(19) United States
(12) Patent Application Publication
(10) Pub. No.: US 2025/0384340 A1
(43) Pub. Date: Dec. 18, 2025

(54) INFORMATION PROCESSING DEVICE, INFORMATION PROCESSING SYSTEM, INFORMATION PROCESSING METHOD, AND COMPUTER PROGRAM PRODUCT

(71) Applicants: KABUSHIKI KAISHA TOSHIBA, Tokyo (JP); TOSHIBA ELECTRONIC DEVICES & STORAGE CORPORATION, Tokyo (JP)

(72) Inventor: Masaaki TAKADA, Kashiwa (JP)

(73) Assignees: KABUSHIKI KAISHA TOSHIBA, Tokyo (JP); TOSHIBA ELECTRONIC DEVICES & STORAGE CORPORATION, Tokyo (JP)

(21) Appl. No.: 19/051,359

(22) Filed: Feb. 12, 2025

(30) Foreign Application Priority Data
Jun. 18, 2024 (JP) 2024-097904

(51) Int. Cl. G06N 20/00; G06F 17/18; G06N 7/02

(52) U.S. Cl. CPC G06N 20/00; G06F 17/18; G06N 7/02

(57) ABSTRACT

An information processing device includes a processing unit including a hardware processor. The hardware processor calculates plural exogenous-noise-estimation values corresponding to plural variables for each of one or more pieces of result data including plural result values respectively corresponding to the plural variables based on the result data and a structural-causal-model representing a causal-relationship of the plural variables. Each of the exogenous-noise-estimation values represents an estimation value of influence by an exogenous-noise different from influences from the plural variables on corresponding variables among the plural variables. The hardware processor generates a contribution-degree representing an influence-magnitude by the exogenous-noise given to a source variable as one of two variables to a target variable that is another variable for each combination of the two variables in the plural variables for the result data based on the structural-causal model and the plural exogenous-noise-estimation values for each result data.

### CROSS-REFERENCE TO RELATED APPLICATIONS

This application is based upon and claims the benefit of priority from Japanese Patent Application No. 2024-097904, filed on Jun. 18, 2024; the entire contents of which are incorporated herein by reference.

### FIELD

Embodiments described herein relate generally to an information processing device, an information processing system, an information processing method, and a computer program product.

### BACKGROUND

A technique of unraveling a complicated structure latent in data using statistics and machine learning is proposed. For example, a technique of analyzing a causal relationship from data using causal discovery and causal inference and improving a prediction method, a decision-making method, and the like is proposed.

For example, in a manufacturing system, causal discovery and causal inference are used to identify factors that influence a product quality and predict influence of process change on the product quality based on raw material data, process data, quality inspection data, maintenance data, and the like. In addition, in an information system, causal relationships between system components are identified, failures are analyzed and performance improvements are achieved.

### BRIEF DESCRIPTION OF THE DRAWINGS

FIG. 1 is a configuration diagram of an information processing system according to an embodiment;

FIG. 2 is a diagram illustrating a structural causal model;

FIG. 3 is a diagram illustrating a causal graph;

FIG. 4 is a configuration diagram of an analysis device;

FIG. 5 is a diagram illustrating a result data matrix;

FIG. 6 is a diagram illustrating an example of an adjacency matrix;

FIG. 7 is a diagram illustrating an exogenous noise matrix;

FIG. 8 is a diagram illustrating a third-order tensor;

FIG. 9 is a diagram illustrating a comparison result between the analysis device and a regression model in the related art;

FIG. 10 is a diagram illustrating an example of a configuration of an output unit;

FIG. 11 is a diagram illustrating a first example of cause information;

FIG. 12 is a diagram illustrating a second example of the cause information;

FIG. 13 is a diagram illustrating a third example of the cause information;

FIG. 14 is a diagram illustrating a fourth example of the cause information;

FIG. 15 is a diagram illustrating a fifth example of the cause information;

FIG. 16 is a diagram illustrating a sixth example of the cause information;

FIG. 17 is a diagram illustrating a seventh example of the cause information;

FIG. 18 is a diagram illustrating an eighth example of the cause information;

FIG. 19 is a diagram illustrating a ninth example of the cause information;

FIG. 20 is a diagram illustrating a first display example of the causal graph and the cause information;

FIG. 21 is a diagram illustrating a second display example of the causal graph and the cause information;

FIG. 22 is a diagram illustrating a third display example of the causal graph and the cause information;

FIG. 23 is a diagram illustrating a modification of the information processing system according to the embodiment; and

FIG. 24 is a hardware configuration diagram of the analysis device.

### DETAILED DESCRIPTION

According to an embodiment, an information processing device includes a processing unit including at least one hardware processor configured to calculate a plurality of exogenous noise estimation values corresponding to a plurality of variables for each of one or more pieces of result data including a plurality of result values respectively corresponding to the plurality of variables based on the one or more pieces of result data and a structural causal model representing a causal relationship of the plurality of variables, where each the plurality of exogenous noise estimation values represents an estimation value of influence by an exogenous noise that is different from influences from the plurality of variables with respect to corresponding variables among the plurality of variables. The hardware processor is configured to generate a degree of contribution representing a magnitude of influence by the exogenous noise given to a source variable that is one variable of two variables to a target variable that is another variable of the two variables for each combination of the two variables in the plurality of variables for the one or more pieces of result data based on the structural causal model and the plurality of exogenous noise estimation values for each of the one or more pieces of result data.

A problem to be solved by the present disclosure is to identify a cause that influences data variation.

Exemplary embodiments of an information processing device, an information processing system, an information processing method, and a computer program product will be explained below in detail with reference to the accompanying drawings. The present disclosure is not limited to the following embodiments.

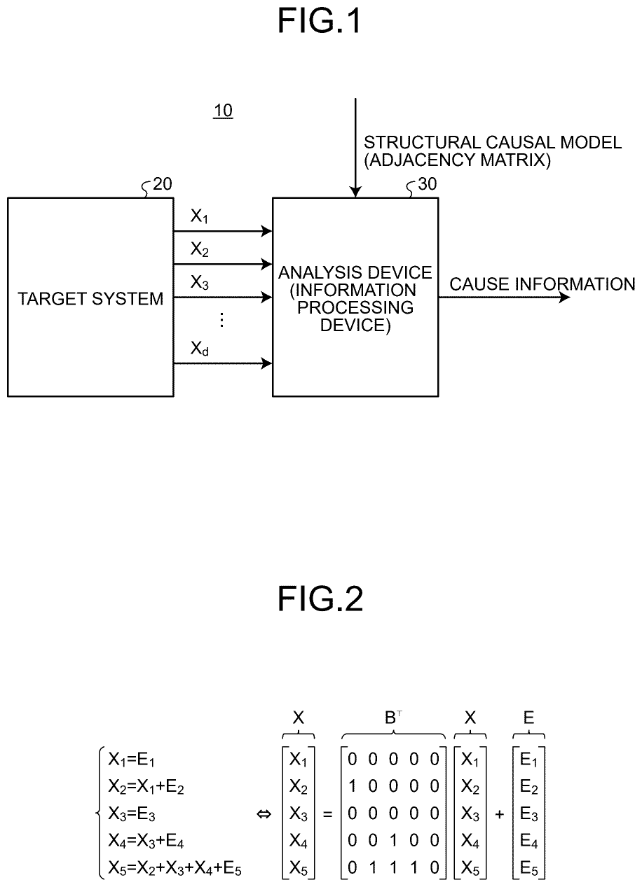

FIG. 1 is a diagram illustrating a configuration of an information processing system 10 according to an embodiment. The information processing system 10 according to the embodiment includes a target system 20 and an analysis device 30.

The target system 20 is, for example, a manufacturing system that manufactures a product. The target system 20 may be a data processing system that executes a computer process or may be an information processing system that provides an information processing service by using information processing. The target system 20 is not limited to such systems and may be any system that handles data.

The analysis device 30 is an information processing device that executes information processing. The analysis device 30 acquires one or more pieces of result data each including a plurality of result values corresponding to a plurality of variables from the target system 20. In the analysis device 30, for example, a structural causal model (SCM) is preset when executing, for example, operation start, initialization, or factory shipment of the target system 20.

The analysis device 30 generates cause information indicative of a cause of a change of at least one variable among the plurality of variables based on the acquired one or more pieces of result data and the preset structural causal model. Then, the analysis device 30 outputs the cause information, for example, by performing display or the like on a display device. For example, the analysis device 30 periodically acquires one or more pieces of result data including result values of a plurality of variables as a stationary task and outputs the cause information to manage the state of the target system 20.

Each of the plurality of variables represents a value sampled in the target system 20. For example, when the target system 20 is a manufacturing system, each of the plurality of variables represents raw material data such as an amount of raw material and a quality of the raw material, process data such as sensor data obtained by detecting an operating time of a device at time of manufacturing and an environment of the manufacturing device by a sensor, quality inspection data representing a quality and the like of a manufactured product, maintenance data detected during maintenance, and the like.

Each of the one or more pieces of result data is a vector including a plurality of result values. In the present embodiment, each of the one or more pieces of result data is a d-dimensional (d is an integer of 2 or more) vector including d result values corresponding to d variables (X₁, X₂, . . . , and X_{d}) on a one-to-one basis.

Each of the one or more pieces of result data includes a plurality of result values sampled from the target system 20 under conditions such as different times. For example, first result data and second result data among one or more pieces of result data are values sampled from the target system 20 at different times. However, the plurality of result values included in one piece of result data are values sampled under same conditions such as the same time.

In the present embodiment, the analysis device 30 acquires result data of n samples (n is an integer of 1 or more). Each of the one or more pieces of result data in the present embodiment is assigned with an index for identifying conditions such as sampled time.

The structural causal model is information representing a causal relationship of a plurality of variables. That is, the structural causal model is information for each set of two variables in the plurality of variables, where the information represents that one variable influences or does not influence another variable in the set of two variables and a magnitude of influence.

In the present embodiment, the structural causal model is a linear model in which a magnitude of influence is represented by a real number and is represented using an adjacency matrix B. The adjacency matrix B represents the magnitude of influence from one variable to the other variable for each combination of two variables in the plurality of variables. In the present embodiment, the number of variables is d, and the adjacency matrix B is represented by a square matrix of d rows and d columns.

Each element in the adjacency matrix B includes a real number value representing the magnitude of influence from a variable identified by a row (one variable) to a variable identified by a column (the other variable). The magnitude of influence from one variable to the other variable may be positive, may be negative, or may be 0. 0 represents that no influence is given from one variable to the other variable. Note that the adjacency matrix B includes the magnitude of influence of a set of variables in which one variable and the other variable are the same. The magnitude of influence of a set in which one variable and the other variable are the same variable is included in diagonal components of the adjacency matrix B and is 0. Note that rows and columns of the adjacency matrix B may be opposite to those in the example of the present embodiment.

Herein, as a method for analyzing a cause of change of a variable having the index of d (X_{d}) in a variable vector X including d variables, single regression analysis and correlation analysis are known in the related art.

The variable vector X is expressed by Formula (1). Each of the d variables (X₁, X₂, . . . , X_{d}) represents a real number. Note that T on the right shoulder represents a transposed matrix.

$$X = {( {X}_{1} , … , {X}_{d} )}^{T} ∈ {ℝ}^{d} \qquad ( 1 )$$

For example, a single regression model with variables having indices of j (Xⱼ) (j=1, 2, . . . , d-1) among the d variables as explanatory variables and the variable having the index of d (X_{d}) as objective variables is expressed by Formula (2).

$${X}_{d} = {β}_{0 j} + {β}_{1 j} {X}_{j} + {ε}_{j} \qquad ( 2 )$$

In Formula (2), ϵⱼ is a noise given to the variable having the index of j (Xⱼ). β₀ⱼ and β₁ⱼ are coefficients of explanatory variables and parameters of the single regression model.

β₀ⱼ and β₁ⱼ are estimated by a least squares method by using result values of the d variables. A determination coefficient of such single regression model matches the square of a correlation coefficient. Therefore, in the single regression analysis and the correlation analysis, the explanatory variable having high estimation accuracy (Xⱼ) is analyzed to have a high correlation with the objective variable (X_{d}).

For example, as another method for analyzing a cause of change of the variable having the index of d (X_{d}) in the variable vector X including the d variables in the related art, multiple regression analysis is also known. A multiple regression model with variables having indices of 1, 2, . . . , and d-1 (X₁, X₂, . . . , X_{d-1},) as explanatory variables and the variable having the index of d (X_{d}) as an objective variable is expressed as in Formula (3).

$${X}_{d} = {β}_{0} + {β}_{1} {X}_{1} + ⋯ + {β}_{d - 1} {X}_{d - 1} + {ε}_{d} \qquad ( 3 )$$

In Formula (3), ϵ_{d} is a noise given to the variable having the index of d (X_{d}). β₀, β₁, . . . , and β_{d-1} are coefficients of explanatory variables and parameters of the multiple regression model.

β₀, β₁, . . . , and β_{d-1} are estimated by a least squares method by using result values of the d variables. When there are many explanatory variables, the multiple regression model may be represented using a part of variables selected from among the d variables using domain knowledge. The multiple regression model may select a part of variables among the d variables, contract a dimension, reduce a dimension, or contract and reduce a dimension by a data-driven method, for example, Ridge, Lasso, PCA, PLS, or the like.

The analysis result using such single regression model has contents such as “when xⱼ that is the result value of the variable having the index of j (Xⱼ) changes by (xⱼ−X_{j_ave}) from X_{j_ave} that is the average value of the variable having the index of j (Xⱼ), there is a tendency that the influence of other variables is ignored and x_{d} that is the result value of the objective variable (X_{d}) changes by +B₁ⱼ(Xⱼ−X_{j_ave})”. The analysis result using a multiple regression model has contents such as “when xⱼ that is the result value of the variable having the index of j (Xⱼ) changes by (xⱼ−X_{j_ave}) from X_{j_ave} that is the average value of the variable having the index of j (Xⱼ), there is a tendency that other variables are fixed and x_{d} that is the result value of the objective variable (X_{d}) changes by +B₁ⱼ(xⱼ−X_{j_ave})”.

However, only statistical relationships of the analysis results of the single regression model and the multiple regression model are reflected in the analysis result and the causal relationship between variable and variable is not guaranteed. Therefore, it is difficult to obtain a causal cause of the change in the objective variable (X_{d}) in the analysis results of the single regression model and the multiple regression model. The analysis result by the single regression model does not consider the influence of other variables. The analysis result by the multiple regression model analyzes the partial correlation while other variables are fixed, so that only an influence of variables directly influenced by Xⱼ is reflected.

Meanwhile, the analysis device 30 according to the present embodiment can output cause information indicative of an indirect cause in addition to a direct cause of the change in the variable using the structural causal model as described below.

FIG. 2 is a diagram illustrating a structural causal model.

In the present embodiment, the structural causal model is expressed as Formula (4).

$${X}_{k} = {\sum }_{j ∈ P a ( k )} {X}_{j} {B}_{jk} + {E}_{k} , ( k = 1 , … , d ) \qquad ( 4 )$$

k and j are indices for identifying any variable among the d variables (X₁, X₂, . . . , X_{d}). Xₖ represents a value of a variable having an index of k (Xₖ) among the d variables (X₁, X₂, . . . , X_{d}). Bⱼₖ is a value of a real number. Bⱼₖ represents a magnitude of influence from the variable having the index of j (Xⱼ) to the variable having the index of k (Xₖ) in a combination of the variable having the index of j (Xⱼ) and the variable having the index of k (Xₖ) among the d variables (X₁, X₂, . . . , X_{d}). Pₐ (k) represents a set of indices of parent variables that directly influence the variable having the index of k (Xₖ).

Eₖ represents an exogenous noise given to the variable having the index of k (Xₖ). The exogenous noise is noise generated by an external factor different from influences from the plurality of variables.

When represented with a matrix, the structural causal model is represented as Formula (5).

$$X = {B}^{T} X + E \qquad ( 5 )$$

E is a vector including d exogenous noises (E₁, E₂, . . . , E_{d}) as in Formula (6).

$$E = {( {E}_{1} , … , {E}_{d} )}^{T} ∈ {ℝ}^{d} \qquad ( 6 )$$

X is a vector including d variables (X₁, X₂, . . . . X_{d}).

B^{T} is a transposed matrix of the adjacency matrix B. In the adjacency matrix B, values of the d×d elements are real numbers as indicated in Formula (7).

$$B ∈ {ℝ}^{d \times d} \qquad ( 7 )$$

Note that there are cases in which B^{T} is referred to as an adjacency matrix, but in the present embodiment, B is set as an adjacency matrix.

The structural causal model can also be represented by a plurality of equations as indicated on the left side of FIG. 2. The structural causal model is also referred to as a structural equation model (SEM).

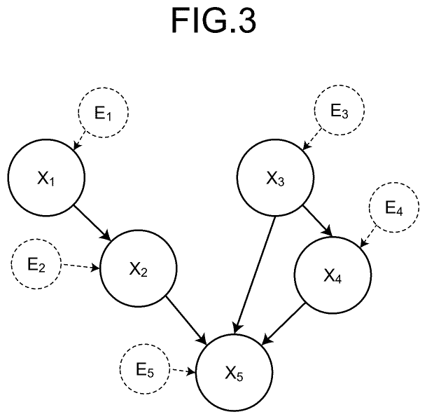

FIG. 3 is a diagram representing a causal graph representing a structural causal model.

A structural causal model is represented by a causal graph that is a directed graph. The causal graph includes d nodes corresponding to d variables (X₁, . . . , X_{d}) on a one-to-one basis.

Bⱼₖ, that is an element of the adjacency matrix B, represents a value corresponding to a directed edge from a node corresponding to the variable having the index of j (Xⱼ) to a node corresponding to the variable having the index of k (Xₖ) in the causal graph.

Note that, when Bⱼₖ is nonzero, the causal graph includes a directed edge from the node corresponding to the variable having the index of j (Xⱼ) to the node corresponding to the variable having the index of k (Xₖ). That is, when Bⱼₖ is zero, the causal graph does not include the directed edge from the node corresponding to the variable having the index of j (Xⱼ) to the node corresponding to the variable having the index of k (Xₖ).

Eₖ represents an exogenous noise influencing the node corresponding to the variable having the index of k (Xₖ).

The analysis device 30 according to the present embodiment outputs cause information indicative of the direct cause and the indirect cause of the change in the variable using the structural causal model as described above.

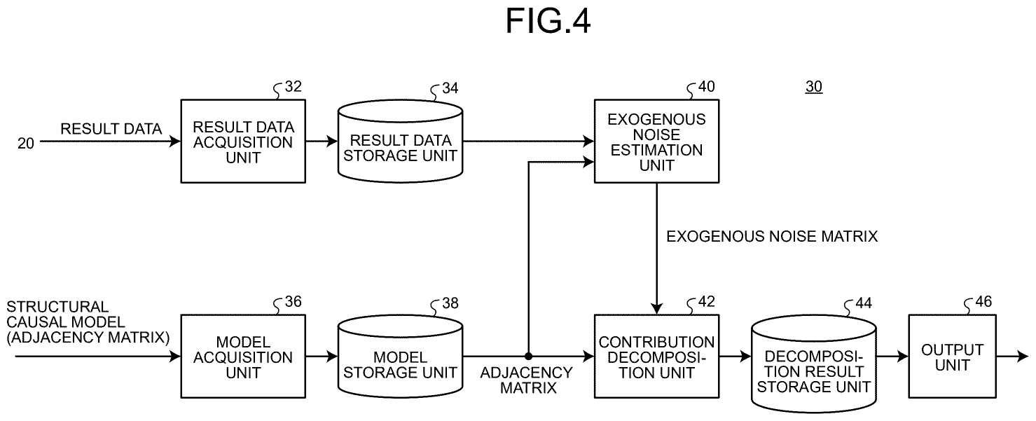

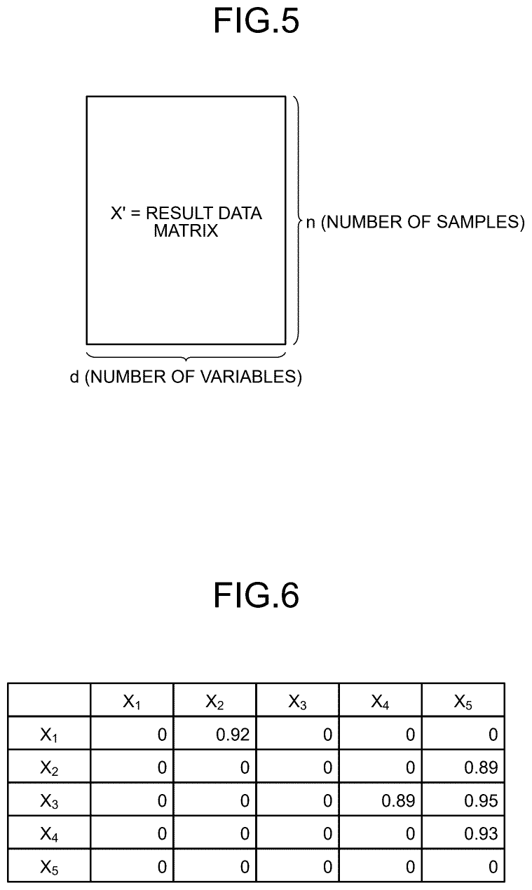

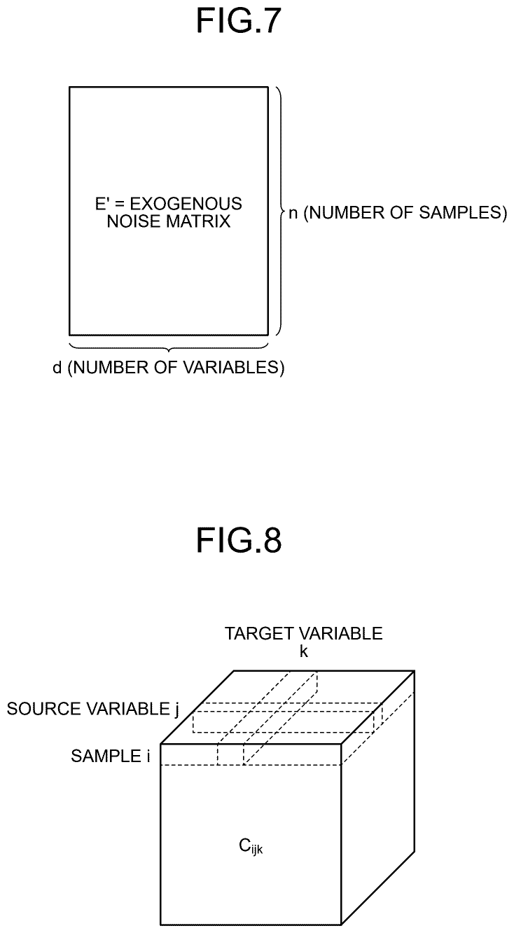

FIG. 4 is a diagram illustrating a configuration of the analysis device 30. Note that FIG. 4 is described with reference to FIGS. 5 to 8. FIG. 5 is a diagram illustrating a result data matrix X′. FIG. 6 is a diagram illustrating an example of the adjacency matrix B. FIG. 7 is a diagram illustrating an exogenous noise matrix E′. FIG. 8 is a diagram illustrating a contribution tensor C.

The analysis device 30 includes a result data acquisition unit 32, a result data storage unit 34, a model acquisition unit 36, a model storage unit 38, an exogenous noise estimation unit 40, a contribution decomposition unit 42, a decomposition result storage unit 44, and an output unit 46.

The result data acquisition unit 32 acquires one or more pieces of result data from the target system 20. In the present embodiment, the result data acquisition unit 32 acquires result data including d result values corresponding to d variables for n samples.

Note that, for example, when there is an intercept in the structural causal model, the result data acquisition unit 32 may execute predetermined processing such as centralization or standardization on a plurality of result values in each of one or more pieces of result data. The result data acquisition unit 32 may add a variable of a fixed value.

The result data storage unit 34 stores the acquired one or more pieces of result data. In the present embodiment, the result data storage unit 34 stores the result data matrix X′ including n rows corresponding to n samples and d columns corresponding to d variables as illustrated in FIG. 5. The element in an i-th row and a j-th column in the result data matrix X′ includes xᵢⱼ that is a result value corresponding to a variable having an index of j among the d variables in a sample having the index of i among the n samples. Note that, in the result data matrix X′, i is an integer of 1 or more and n or less. j is an integer of 1 or more and d or less.

The model acquisition unit 36 acquires the structural causal model. In the present embodiment, the model acquisition unit 36 acquires the adjacency matrix B. The adjacency matrix B is generated in advance by a device other than the analysis device 30 or a user. Note that the adjacency matrix B may be generated by the model acquisition unit 36 based on one or more pieces of result data.

The adjacency matrix B is estimated, for example, by using a causal discovery algorithm based on one or more result data. For example, the adjacency matrix B may be estimated by using an algorithm such as multiple regression or Adaptive Lasso after a causal order is defined using domain knowledge.

For example, the adjacency matrix B may be estimated by using a known causal structure and covariance structure analysis based on one or more pieces of result data. For example, the adjacency matrix B may be estimated by using information concerning presence or absence of a cause and effect between variables and a causal discovery algorithm based on one or more pieces of result data. For example, the adjacency matrix B may be estimated by using a causal discovery algorithm under assumption of non-Gaussianity, nonlinearity, equality of variances, or the like. Note that non-Gaussianity is disclosed in Shimizu, S., Hoyer, P. O., Hyvarinen, A., Kerminen, A., & Jordan, M., “A linear non-Gaussian acyclic model for causal discovery”, published in 2006, Journal of Machine Learning Research, 7(10), Shimizu, S., Inazumi, T., Sogawa, Y., Hyvarinen, A., Kawahara, Y., Washio, T., & Hoyer, P. O.,

“DirectLINGAM: A direct method for learning a linear non-Gaussian structural equation model”, published in 2011, Journal of Machine Learning Research-JMLR, 12 April, pages 1225 to 1248, and Hyvarinen, A., & Smith, S. M., “Pairwise likelihood ratios for estimation of non-Gaussian structural equation models”, published in 2013, The Journal of Machine Learning Research, 14(1), pages 111 to 152. Nonlinearity is disclosed in Hoyer, P., Janzing, D., Mooij, J. M., Peters, J., & Scholkopf, B., “Nonlinear causal discovery with additive noise models”, published in 2008, Advances in neural information processing systems, 21, and Peters, J., Mooij, J. M., Janzing, D., & Scholkopf, B., “Causal Discovery with Continuous Additive Noise Models”, published in 2014, Journal of Machine Learning Research, 15, pages 2009 to 2053. Equality of variances is disclosed in Peters, J., & Buhlmann, P., “Identifiability of Gaussian structural equation models with equal error variances”, published in 2014, Biometrika, 101 (1), pages 219 to 228.

The one or more pieces of result data used for estimating the adjacency matrix B may be data acquired by the analysis device 30 or may be data different from the data acquired by the analysis device 30, for example, data in a past normal period.

When d=5, the adjacency matrix B is indicated as in FIG. 6. Each element in the adjacency matrix B represents a magnitude of influence from one variable identified by a row to another variable identified by a column.

The model storage unit 38 stores the structural causal model acquired by the model acquisition unit 36. In the present embodiment, the model storage unit 38 stores the adjacency matrix B.

The exogenous noise estimation unit 40 calculates the plurality of exogenous noise estimation values corresponding to the plurality of variables for each of the one or more pieces of result data based on the one or more pieces of result data stored in the result data storage unit 34 and the structural causal model acquired by the model acquisition unit 36. The plurality of exogenous noise estimation values correspond to the plurality of variables on a one-to-one basis. Each of the plurality of exogenous noise estimation values represents an estimation value of an influence of exogenous noise on a corresponding variable among the plurality of variables.

In the present embodiment, the exogenous noise estimation unit 40 generates an exogenous noise matrix E′. The exogenous noise matrix E′ includes a plurality of exogenous noise estimation values for each of the one or more pieces of result data.

For example, the exogenous noise matrix E′ includes n rows corresponding to n samples and d columns corresponding to d variables as illustrated in FIG. 7. An element included in an i-th row and a j-th column in the exogenous noise matrix E′ include eᵢⱼ, that is an exogenous noise estimation value obtained by estimating an exogenous noise included given to a variable having the index of j among the d variables in a sample having the index of i among the n samples. eᵢⱼ is represented by a real number.

The exogenous noise estimation unit 40 calculates the exogenous noise matrix E′ by Formula (8).

$${E}^{′} = {X}^{′} ( I - B ) \qquad ( 8 )$$

Note that I represents an identity matrix. That is, the exogenous noise estimation unit 40 calculates the exogenous noise matrix E′ by multiplying the result data matrix X′ by a matrix (I-B) obtained by subtracting the adjacency matrix B from an identity matrix I.

The contribution decomposition unit 42 generates a degree of contribution representing a magnitude of influence on a target variable that is one of two variables by an exogenous noise given to a source variable that is the other of the two variables for each combination of two variables in the plurality of variables in each of the one or more pieces of result data based on the structural causal model and the plurality of exogenous noise estimation values for each of the one or more pieces of result data.

Hereinafter, the degree of contribution is further described.

When Formula (8) is transformed, the result data matrix X′ is expressed as Formula (9).

$${X}^{′} = {{E}^{′} ( I - B )}^{- 1} \qquad ( 9 )$$

When (I-B)⁻¹ is defined as a coefficient matrix A, the result data matrix X′ is expressed by Formula (10).

$${X}^{′} = {E}^{′} A \qquad ( 10 )$$

When the causal graph is an acyclic graph, by appropriately rearranging the order of variables, the adjacency matrix B becomes a strict upper triangular matrix having diagonal components of 0. Therefore, (I-B) has an inverse matrix. That is, the coefficient matrix A=(I-B)⁻¹, that is an inverse matrix of (I-B), is an upper triangular matrix having diagonal components of 1. Note that the order of the plurality of variables when arranged as such is referred to as a causal order. It is likely that a causal graph representing a structural causal model includes a directed edge from a node corresponding to a variable of any first rank in the causal order to a node corresponding to a variable of any second rank greater than the first rank in the causal order. However, the causal graph does not include a directed edge from the node corresponding to the variable of the second rank to the node corresponding to the variable of the first rank.

When the causal graph is not an acyclic graph, (I-B) does not necessarily have an inverse matrix. Therefore, the coefficient matrix A may be (I-B)⁺, that is a generalized inverse matrix, instead of (I-B)⁻¹.

An element in an i-th row and a k-th column (k is an integer of 1 or more and d or less) in X′=E′A is Xᵢₖ. Xᵢₖ is expressed as Formula (11).

$${x}_{ik} = {\sum }_{j = 1}^{k - 1} {A}_{jk} {e}_{ij} + {e}_{ik} \qquad ( 11 )$$

Xᵢₖ expressed by Formula (11) represents a result value of a variable having the index of k among the d variables in result data of a sample having the index of i among the n samples.

The right side of Formula (11) is a linear sum formula that sums up a plurality of terms. That is, Xᵢₖ is expressed by a linear sum formula that sums up a plurality of terms.

The linear sum formula on the right side of Formula (11) includes (k-1) Aⱼₖeᵢⱼ terms and one eᵢₖ term.

eᵢₖ represents a value of an element of an i-th row and a k-th column in the exogenous noise matrix E′. That is, eᵢₖ is an exogenous noise estimation value representing an exogenous noise given to a variable having the index of k in result data of a sample having the index of i.

eᵢⱼ represents a value of an element of an i-th row and a j-th column in the exogenous noise matrix E′. That is, eᵢⱼ is an exogenous noise estimation value representing an exogenous noise given to a variable having the index of j in the result data of the sample having the index of i.

Aⱼₖ represents a value of an element of a j-th row and a k-th column in the coefficient matrix A=(I-B)⁻¹.

Here, in Formula (11), the variable having the index of j is positioned upstream of the variable having the index of k on the causal graph. That is, the variable having the index of j has a smaller causal order than the variable having the index of k. Therefore, eᵢⱼ is an exogenous noise estimation value representing the exogenous noise given to the variable that is likely to directly influence Xᵢₖ or an exogenous noise estimation value representing the exogenous noise given to the variable that is likely to indirectly influence Xᵢₖ, Xᵢₖ being the result value of the variable having the index of k in the sample having the index of i.

That is, Aⱼₖeᵢⱼ in the linear sum formula on the right side of Formula (11) represents an influence of the exogenous noise given to the variable that is likely to directly or indirectly influence xᵢₖ that is the result value of the variable having the index of k in the sample having the index of i.

Note that, when the adjacency matrix B is a strict upper triangular matrix with the diagonal components of 0, the coefficient matrix A is an upper triangular matrix with diagonal components of 1 and with the lower side of the diagonal components of 0. Therefore, here, Formula (11) may be expressed as Formula (12).

$${x}_{ik} = {\sum }_{j = 1}^{d} {A}_{jk} {e}_{ij} \qquad ( 12 )$$

The linear sum formula on the right side of Formula (12) is a formula that sums up values obtained by multiplying each of eᵢⱼ that is a plurality of exogenous noise estimation values in the result data of the sample having the index of i by the corresponding coefficient Aⱼₖ in the coefficient matrix A. That is, the linear sum formula on the right side of Formula (12) is a formula for performing the product-sum operation of a row corresponding to the result data of the sample having the index of i in the exogenous noise matrix E′ and a column corresponding to the variable having the index of k in the coefficient matrix A. However, since the coefficient matrix A is an upper triangular matrix in which the lower side of the diagonal components is 0, Aⱼₖeᵢⱼ in the linear sum formula of the right side of Formula (12) is 0 when j is larger than k.

The contribution decomposition unit 42 generates Ajkeij expressed by Formula (11) or Formula (12) as a degree of contribution for each combination of two variables in the plurality of variables for each of the one or more pieces of result data. That is, the contribution decomposition unit 42 generates Aⱼₖeᵢⱼ in the linear sum formula on the right side of Formula (11) or Formula (12) as the degree of contribution of the exogenous noise given to Xᵢₖ that is the variable having the index of k in the sample having the index of i with respect to Xᵢₖ that is result value of the variable having the index of k in the sample having the index of i. Such a degree of contribution represents the magnitude of influence of the exogenous noise given on the target variable that is the other of the two variables to the source variable that is one of the two variables. Note that the contribution decomposition unit 42 also generates the degree of contribution for a combination of two variables in which the source variable and the target variable are the same variable.

For example, when a first variable among the plurality of variables is set as the target variable and a second variable among the plurality of variables is set as the source variable in the first result data among the one or more pieces of result data, a degree of contribution to the combination of the two variables is a value of a term including the exogenous noise estimation value representing the exogenous noise given to the second variable among a plurality of terms in the linear sum formula. Here, the linear sum formula is a formula for performing a product-sum operation of a row corresponding to the first result data in the exogenous noise matrix E′ and a column corresponding to the first variable in the coefficient matrix A. The coefficient matrix A is the inverse matrix (I-B)⁻¹ of the matrix (I-B) obtained by subtracting the adjacency matrix B from the identity matrix I or the generalized inverse matrix (I-B)⁺.

For example, with respect to the result data of the sample having the index of i (first result data), the degree of contribution when the variable having the index of k (first variable) is set as the target variable and the variable having the index of j (second variable) is set as the source variable is Aⱼₖeᵢⱼ. Note that, with respect to the result data of the sample having the index of i (first result data), when both the target variable and the source variable are variables having the index of k (first variable), the degree of contribution is eᵢₖ.

In the present embodiment, the contribution decomposition unit 42 generates a contribution tensor C that is a third-order tensor. The contribution tensor C includes an i component, a j component, and a k component.

The i component corresponds to each of one or more pieces of result data. In the present embodiment, the i component corresponds to each piece of result data of n samples.

The j component and the k component correspond to each of a plurality of variables. In the present embodiment, the j component and the k component correspond to each of d variables.

In the present embodiment, the contribution decomposition unit 42 calculates Cᵢⱼₖ that is an element of the i component, the j component, and the k component in the contribution tensor C by Formula (13).

$${C}_{ijk} = {e}_{ij} {A}_{jk} \qquad ( 13 )$$

That is, as illustrated in FIG. 8, each of the plurality of elements in the contribution tensor C represents a degree of contribution for the result data identified by the i component among the one or more pieces of result data, in which a variable identified by the j component among the plurality of variables is set as a source variable and a variable identified by the k component among the plurality of variables is set as a target variable.

Formula (14) is valid for the plurality of elements in the contribution tensor C.

$${x}_{ik} = {\sum }_{j = 1}^{d} {C}_{ijk} \qquad ( 14 )$$

That is, each of the plurality of elements in the contribution tensor C represents a term in the linear sum formula for each of the one or more pieces of result data. Therefore, by calculating the contribution tensor C, the contribution decomposition unit 42 can calculate a result obtained by comprehensively analyzing presence of other variables that cause a change in at least one variable among the plurality of variables.

Note that the contribution decomposition unit 42 may include a value obtained by converting the numerical value indicated in Formula (13) according to a predetermined rule in the element of the contribution tensor C. For example, the contribution decomposition unit 42 may include a sign indicating positive or negative of the numerical value indicated in Formula (13), an absolute value, a value indicating inclusion or exclusion of the numerical value in a range from a predetermined upper limit value to a lower limit value, a value obtained by leveling the numerical value indicated in Formula (13) in a predetermined stage, or the like.

The decomposition result storage unit 44 stores the degree of contribution for each combination of two variables in the plurality of variables for each of the one or more pieces of result data calculated by the contribution decomposition unit 42. In the present embodiment, the decomposition result storage unit 44 stores the contribution tensor C.

The output unit 46 outputs the degree of contribution for each set of two variables in the plurality of variables for each of the one or more pieces of result data stored in the decomposition result storage unit 44 by, for example, causing the display device to display the degree of contribution. In the present embodiment, the output unit 46 outputs a value of at least one element in the contribution tensor C stored in the decomposition result storage unit 44 or a value obtained by converting a value of at least one element in the contribution tensor C stored in the decomposition result storage unit 44.

The output unit 46 may receive selection of at least one piece of result data of interest indicating a sample of interest among the one or more pieces of result data. The output unit 46 may receive selection of at least one source variable of interest that is focused as a source variable among the plurality of variables. The output unit 46 may receive selection of at least one target variable of interest that is focused as a target variable among the plurality of variables. Note that the output unit 46 may receive selection of at least one piece of result data of interest, at least one source variable of interest, and at least one target variable of interest according to an operation of the user or may receive the selection based on preset information.

Then, the output unit 46 outputs the degree of contribution corresponding to all or a part of combinations of at least one piece of selected result data of interest, at least one selected source variable of interest, and at least one selected target variable of interest, as cause information. For example, the output unit 46 causes the display device or the like to display the cause information that is a table or a graph representing the degree of contribution corresponding to all or a part of combinations of at least one piece of selected result data of interest, at least one selected source variable of interest, and at least one selected target variable of interest. Note that a specific example of the information displayed by the output unit 46 is described below in detail.

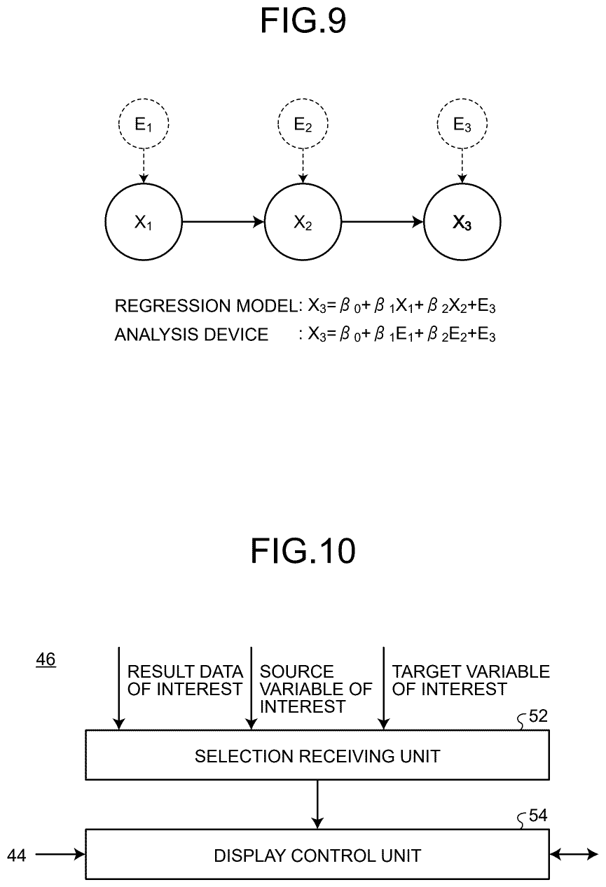

FIG. 9 is a diagram illustrating a comparison result between the analysis device 30 according to the present embodiment and a regression model in the related art.

When a change in a specific variable is analyzed by using a regression model in the related art, the specific variable is represented by a formula that adds a constant to a term obtained by multiplying a result value of another variable with a coefficient. For example, when a change in X₃ among three variables of X₁, X₂, and X₃ is analyzed by using the regression model in the related art, X₃ is represented by Formula (15).

$${X}_{3} = {β}_{0} + {β}_{1} {X}_{1} + {β}_{2} {X}_{2} + {E}_{3} \qquad ( 15 )$$

However, when the change in X₃ represented by such regression model is analyzed by a multiple regression method in the related art, β₁ that is a regression coefficient of X₁ that is a variable indirectly influencing X₃ has a value almost close to 0. Therefore, when a change in a specific variable is analyzed by using a regression model in the related art, it is not possible to consider an influence of a variable that indirectly influences the specific variable.

Meanwhile, when the analysis device 30 according to the present embodiment analyzes the change of the specific variable, the specific variable is represented by a formula that adds a term obtained by multiplying the exogenous noise estimation value given to each variable with the coefficient. For example, when a change in X₃ among three variables of X₁, X₂, and X₃ is analyzed by using the analysis device 30, X₃ is represented by Formula (16).

$${X}_{3} = {β}_{0} + {β}_{1} {E}_{1} + {β}_{2} {E}_{2} + {E}_{3} \qquad ( 16 )$$

As described above, when the change in X₃ is analyzed by the analysis device 30, in addition to the degree of contribution of X₂ (β₂E₂ in Formula (16)) that is a variable directly influencing X₃, the degree of contribution of X₁ (β₁E₁ in Formula (16)) that is a variable indirectly influencing X₃ can also be considered. For example, when the influence of the exogenous noise applied to X₁ is transmitted to X₃ via X₂ due to application of a large exogenous noise to X₁, the analysis device 30 can identify that the root of the cause of the change in X₃ is the exogenous noise applied to X₁.

As described above, according to the analysis device 30 of the present embodiment, it is possible to identify variables that directly and indirectly influence the variation in the result data of any variable among the plurality of variables.

Note that Budhathoki, K., Minorics, L., Blobaum, P., & Janzing, D., “Causal structure-based root cause analysis of outliers”, published in June 2022, In International Conference on Machine Learning, pages 2357 to 2369, PMLR discloses a technique for identifying a root cause when a target variable becomes an abnormal value. The technique of Budhathoki, K., Minorics, L., Blobaum, P., & Janzing, D., “Causal structure-based root cause analysis of outliers”, published in June 2022, In International Conference on Machine Learning, pages 2357 to 2369, PMLR calculates an abnormality degree score such as a z score for a target variable and decomposes the abnormality degree score into exogenous noise of each variable by using a Shapley Value. Since the technique of Budhathoki, K., Minorics, L., Blobaum, P., & Janzing, D., “Causal structure-based root cause analysis of outliers”, published in June 2022, In International Conference on Machine Learning, pages 2357 to 2369, PMLR decomposes the abnormality degree score, it is necessary to calculate the Shapley Value, and the amount of calculation is large. Since the technique of Budhathoki, K., Minorics, L., Blobaum, P., & Janzing, D., “Causal structure-based root cause analysis of outliers”, published in June 2022, In

International Conference on Machine Learning, pages 2357 to 2369, PMLR converts the target variable into the abnormality degree score, the result greatly differs depending on which abnormality degree score is used. In the technique of Budhathoki, K., Minorics, L., Blobaum, P., & Janzing, D., “Causal structure-based root cause analysis of outliers”, published in June 2022, In International Conference on Machine Learning, pages 2357 to 2369, PMLR, it is difficult to interpret the factorial decomposition result.

Meanwhile, since the analysis device 30 according to the present embodiment converts the target variable into the abnormality (anomaly) degree score, it is not necessary to select the type of abnormality degree score, and a stable result can be obtained. Since the degree of contribution is calculated by a linear algebra operation, the amount of calculation is small, and since the degree of contribution is calculated for each sample and each variable, the analysis device 30 according to the present embodiment can also easily interpret the result of the factor analysis.

Strobl, E. V., & Lasko, T. A., “Identifying patient-specific root causes of disease”, published in August 2022, In Proceedings of the 13th ACM International Conference on Bioinformatics, Computational Biology and Health Informatics, pages 1 to 10 and Strobl, E., & Lasko, T. A., “Sample-specific root causal inference with latent variables”, published in August 2023, In Conference on Causal Learning and Reasoning, pages 895 to 915, PMLR disclose techniques for identifying the root cause when the target variable is 0 or 1. In the techniques of Strobl, E. V., & Lasko, T. A., “Identifying patient-specific root causes of disease”, published in August 2022, In Proceedings of the 13th ACM International Conference on Bioinformatics, Computational Biology and Health Informatics, pages 1 to 10 and Strobl, E., & Lasko, T. A.,

“Sample-specific root causal inference with latent variables”, published in August 2023, In Conference on Causal Learning and Reasoning, pages 895 to 915, PMLR, it is assumed that the object variable is a terminal node, that is, a node having no child variable, and a logistic regression model using another variable as the object variable is constructed. Then, the techniques of Strobl, E. V., & Lasko, T. A., “Identifying patient-specific root causes of disease”, published in August 2022, In Proceedings of the 13th ACM International Conference on Bioinformatics, Computational Biology and Health Informatics, pages 1 to 10 and Strobl, E., & Lasko, T. A., “Sample-specific root causal inference with latent variables”, published in August 2023, In Conference on Causal Learning and Reasoning, pages 895 to 915, PMLR decompose the logarithm odds of the target variable into exogenous noise by using the Shapley Value. In the techniques disclosed in Strobl, E. V., & Lasko, T. A., “Identifying patient-specific root causes of disease”, published in August 2022, In Proceedings of the 13th ACM International Conference on Bioinformatics, Computational Biology and Health Informatics, pages 1 to 10 and Strobl, E., & Lasko, T. A., “Sample-specific root causal inference with latent variables”, published in August 2023, In Conference on Causal Learning and Reasoning, pages 895 to 915, PMLR, calculation is performed by using the regression coefficient of the logistic regression without calculating the Shapley Value itself, but the target variable needs to be the terminal node and a variable having a value of 0 or 1.

Meanwhile, the analysis device 30 according to the present embodiment can use a continuous variable as an analysis target, the variable to be analyzed is not necessarily a terminal node, and various variables can be analyzed. The analysis device 30 according to the embodiment does not necessarily combine another model such as logistic regression in addition to the structural causal model and can perform analysis easily.

FIG. 10 is a diagram illustrating an example of a configuration of the output unit 46. For example, the output unit 46 includes a selection receiving unit 52 and a display control unit 54.

The selection receiving unit 52 receives selection of at least one piece of result data of interest among one or more pieces of result data. The selection receiving unit 52 receives selection of at least one source variable of interest among the plurality of variables. The selection receiving unit 52 receives selection of at least one target variable of interest among the plurality of variables.

Note that regarding the selection of at least one piece of result data of interest, at least one source variable of interest, and at least one target variable of interest, the selection receiving unit 52 may receive selection from the user or may receive, for example, a preset value as a selected value.

The display control unit 54 reads the degrees of contribution from the decomposition result storage unit 44 for each of all combinations of source variables of interest and target variables of interest in the at least one selected source variable of interest and the at least one selected target variable of interest for each of the at least one piece of selected result data of interest.

Then, the display control unit 54 outputs the read degree of contribution as cause information. For example, the display control unit 54 causes the display device to display the cause information indicative of the degrees of contribution for each of all combinations of the source variables of interest and the target variables of interest by a table or a graph.

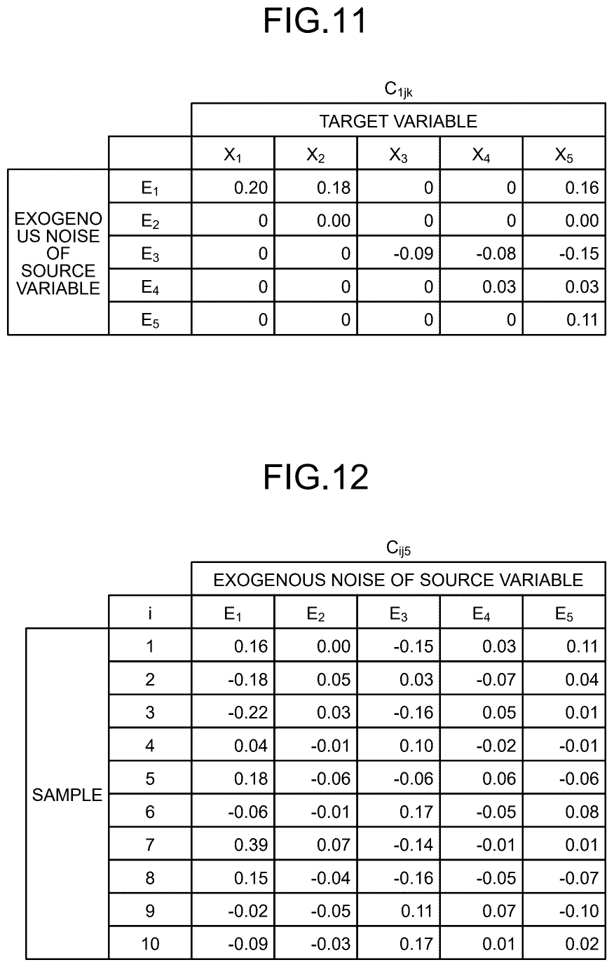

FIG. 11 is a diagram illustrating a first example of the cause information.

For example, the display control unit 54 may output the cause information of the first example as illustrated in FIG. 11 that includes a table in which one of the source variable of interest and the target variable of interest is a row and the other is a column. Here, the display control unit 54 includes the numerical value of the corresponding degree of contribution in the cell in the table.

For example, when the selection of the result data of i=1 is received as the result data of interest, the selection of the variables of j=1 to 5 is received as the source variables of interest, and the selection of the variables of k=1 to 5 is received as the target variables of interest, the display control unit 54 reads the values of the elements of C₁ⱼₖ (j=1 to 5, k=1 to 5) in the contribution tensor C from the decomposition result storage unit 44. Then, the display control unit 54 outputs, as the cause information, a table including the values of the elements of C₁ⱼₖ (j=1 to 5, k=1 to 5) in the contribution tensor C in the cells and including the j components as a row and the k components as a column as illustrated in FIG. 11.

The display control unit 54 can indicate to the user how the exogenous noises (E₁ to E₅) given to the source variables of interest of j=1 to 5 influence the target variables of interest of k=1 to 5 (X₁ to X₅) for the result data of interest of i=1. As a result, the user can easily confirm which exogenous noise of the source variables of interest of j32 1 to 5 causes a change in the value of each of the target variables of interest of k=1 to 5.

FIG. 12 is a diagram illustrating a second example of the cause information.

For example, the display control unit 54 may output the cause information of the second example as illustrated in FIG. 12 that includes a table in which one of the result data of interest and the source variable of interest is a row and the other is a column. Here, the display control unit 54 includes the numerical value of the corresponding degree of contribution in the cell in the table.

For example, when the selection of the result data of i=1 to 10 is received as the result data of interest, the selection of the variables of j=1 to 5 is received as the source variables of interest, and the selection of the variable of k=5 is received as the target variable of interest, the display control unit 54 reads the values of the elements of Cᵢⱼ₅ (i=1 to 10, j=1 to 5) in the contribution tensor C from the decomposition result storage unit 44. Then, the display control unit 54 outputs, as the cause information, a table including the values of the elements of Cᵢⱼ₅ (i=1 to 10, j=1 to 5) in the contribution tensor C in the cells and including the i components as a row and the j components as a column as illustrated in FIG. 12.

The display control unit 54 can indicate to the user how the influence of the exogenous noises (E₁ to E₅) given to each of the source variables of interest of j=1 to 5 on the target variable of interest of k=5 (X₅) changes for the result data of interest of i=1 to 10. As a result, the user can easily confirm which exogenous noise of the source variables of interest of j=1 to 5 influences the change in the value of the target variable of interest of k=5 for each piece of the result data of interest of i=1 to 10.

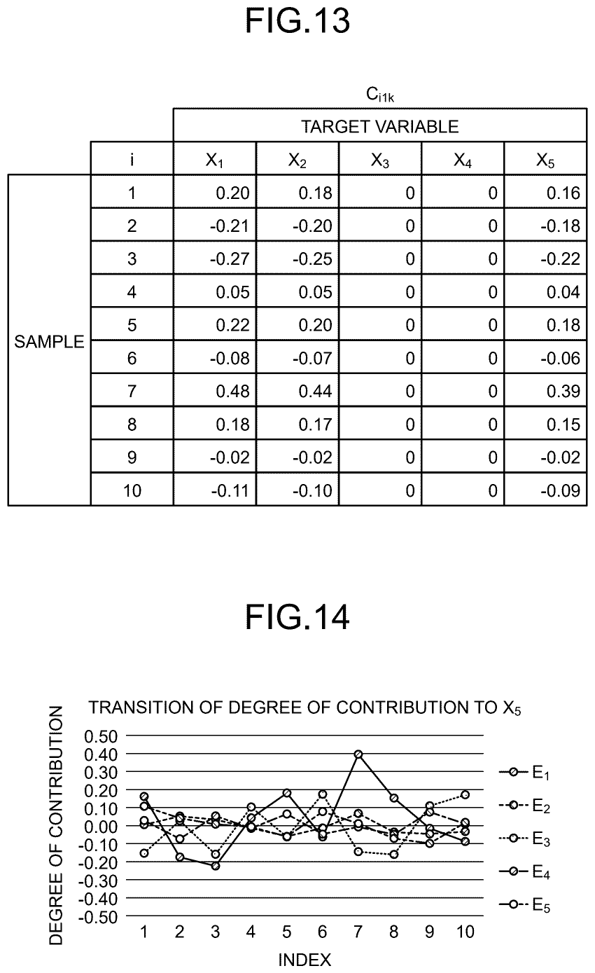

FIG. 13 is a diagram illustrating a third example of the cause information.

For example, the display control unit 54 may output the cause information of the third example as illustrated in FIG. 13 which includes a table in which one of the result data of interest and the target variable of interest is a row and the other is a column. Here, the display control unit 54 includes the corresponding degree of contribution in the cell in the table.

For example, when the selection of the result data of i=1 to 10 is received as the result data of interest, the selection of the variable of j=1 is received as the source variable of interest, and the selection of the variables of k=1 to 5 is received as the target variable of interest, the display control unit 54 reads the values of the elements of Cᵢ₁ₖ (i=1 to 10, k=1 to 5) in the contribution tensor C from the decomposition result storage unit 44. Then, the display control unit 54 outputs, as the cause information, a table including the values of the elements of Cᵢ₁ₖ (i=1 to 10, k=1 to 5) in the contribution tensor C in the cells and including the i components as a row and the k components as a column as illustrated in FIG. 13.

The display control unit 54 can indicate to the user how the influence of the exogenous noise (E₁) given to the source variable of interest of j=1 (X₁) on each of the target variables of interest of k=1 to 5 (X₁ to X₅) changes for the result data of interest of i=1 to 10. As a result, the user can easily confirm which one of the target variables of interest of k=1 to 5 is influenced by the exogenous noise of the source variable of interest of j=1 for each piece of the result data of interest of i=1 to 10.

FIG. 14 is a diagram illustrating a fourth example of the cause information.

For example, the display control unit 54 may output the cause information of the fourth example as illustrated in FIG. 14 including a graph corresponding to each of at least one source variable of interest depicted in a planar area. In this case, in the planar area, a horizontal axis that is an example of a first axis represents an index for identifying the order of each of the plurality of pieces of result data of interest and a vertical axis that is an example of a second axis represents a degree of contribution. Here, the graph corresponding to each of the at least one source variable of interest represents the degree of contribution that is given to the target variable of interest by the exogenous noise given to the source variable of interest corresponding to the index. For example, the display control unit 54 outputs a graph in which line types or plotted mark shapes are changed for each source variable of interest.

For example, the display control unit 54 can visually indicate to the user how the influence by the exogenous noise given to each of the at least one source variable of interest to the target variable of interest transitions according to the change in the index of the result data of interest.

The vertical axis that is the second axis of the planar area in the cause information of the fourth example illustrated in FIG. 14 may further represent the result value of the target variable of interest. Then, the display control unit 54 may output cause information further including a graph that represents the result value of the target variable of interest for each of the plurality of pieces of selected result data of interest and that is in the planar area. A total value of the degrees of contribution by the plurality of source variables of interest is the result value of the target variable of interest. Therefore, by outputting the cause information further including the graph representing the result value of the target variable of interest, the display control unit 54 can visually indicate to the user at what ratio the degree of contribution by the exogenous noise of each of the at least one source variable of interest is decomposed and how the ratio of the degree of contribution transitions.

FIG. 15 is a diagram illustrating a fifth example of the cause information.

For example, the display control unit 54 may output the cause information of the fifth example as illustrated in FIG. 15 including a circular graph or a bar graph representing the ratio of the degree of contribution by each of the plurality of source variables of interest for the result data of interest.

Here, the display control unit 54 calculates the ratio of the degree of contribution by the exogenous noise of each of the plurality of selected source variables of interest to the target variable of interest for the result data of interest. For example, the display control unit 54 calculates the ratio of the magnitude of the degree of contribution by the exogenous noise of the corresponding source variable of interest to the total value of the magnitudes of the degrees of contribution by all the exogenous noise of the plurality of source variables of interest as the ratio of the degree of contribution by the exogenous noise of each of the plurality of selected source variables of interest.

Alternatively, the display control unit 54 calculates the ratio of a statistical value of the degree of contribution by the exogenous noise of the corresponding source variable of interest to the target variable of interest with respect to the total value of the statistical value of the degree of contribution by the exogenous noise of each of the plurality of source variables of interest to the target variable of interest as the ratio of the degree of contribution of the exogenous noise of each of the plurality of selected source variables of interest. The statistical value of the degree of contribution is, for example, a variance of the degrees of contribution, a standard deviation of the degrees of contribution, a sum of squares of the degrees of contribution, or a square root of the sum of squares of the degrees of contribution.

The display control unit 54 generates a circular graph representing the ratio of the degree of contribution by each of the plurality of selected source variables of interest to the target variable of interest for the result data of interest. Alternatively, the display control unit 54 may generate a bar graph depicted in a plane area in which a horizontal axis represents information for identifying each of the plurality of source variables of interest and a vertical axis represents a ratio, and indicating the ratio of the degree of contribution by the exogenous noise of each of the plurality of selected source variables of interest to the target variable of interest.

The display control unit 54 can visually indicate to the user the ratio of the degree of contribution by the exogenous noise of each of the plurality of source variables of interest to the target variable of interest for the result data of interest.

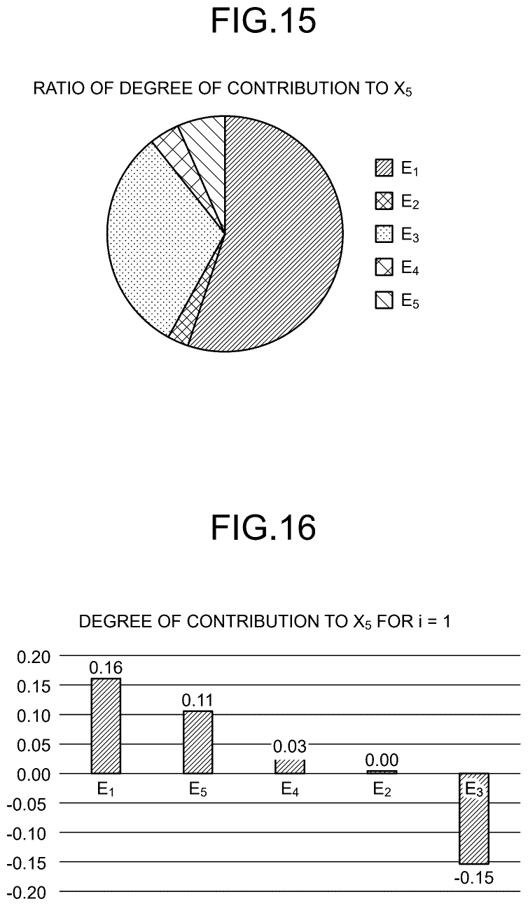

FIG. 16 is a diagram illustrating a sixth example of the cause information.

For example, the display control unit 54 may output the cause information of the sixth example as illustrated in FIG. 16 including a bar graph corresponding to each of the plurality of source variables of interest depicted in the planar area. Here, in the planar area, the horizontal axis that is an example of the first axis represents information for identifying the exogenous noises of the plurality of source variables of interest, and the vertical axis that is an example of the second axis represents the degrees of contribution. Then, here, the bar graph corresponding to each of the plurality of source variables of interest represents the magnitude of the degree of contribution. Note that the display control unit 54 may rearrange the positions of the plurality of source variables of interest on the horizontal axis according to the degree of contribution or the absolute value of the degree of contribution.

The display control unit 54 can visually indicate to the user the degree of contribution by the exogenous noise of each of the plurality of source variables of interest to the target variable of interest for the result data of interest.

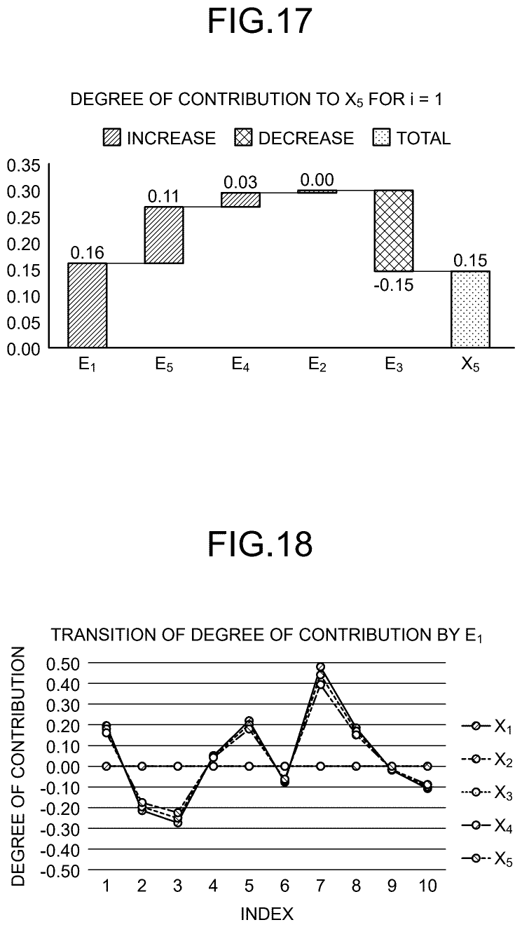

FIG. 17 is a diagram illustrating a seventh example of the cause information.

For example, the display control unit 54 may output the cause information of the seventh example as illustrated in FIG. 17 including a waterfall graph corresponding to each of the plurality of source variables of interest depicted in the planar area. Here, in the planar area, the horizontal axis that is an example of the first axis represents information for identifying the exogenous noises of the plurality of source variables of interest and information for identifying the total value. In the planar area, the vertical axis that is an example of the second axis represents the magnitude of the degree of contribution.

Then, here, the waterfall graph corresponding to each of the plurality of source variables of interest represents the absolute value of the degree of contribution. Note that, in the waterfall graph corresponding to each of the plurality of source variables of interest, the position in the vertical axis direction in the planar area is set to represent the increase or decrease from the adjacent variable. Note that the display control unit 54 may rearrange the positions of the plurality of source variables of interest and the total value on the horizontal axis according to the magnitude of the degree of contribution or the absolute value of the degree of contribution.

The total value of the waterfall graph represents the result value of the target variable of interest. Therefore, the display control unit 54 can visually indicate to the user how the degree of contribution by the exogenous noise of each of the plurality of source variables of interest to the target variable of interest for the result data of interest is decomposed.

FIG. 18 is a diagram illustrating an eighth example of the cause information.

For example, the display control unit 54 may output the cause information of the eighth example as illustrated in FIG. 18 including a graph corresponding to each of at least one target variable of interest depicted in the planar area. Here, in the planar area, the horizontal axis that is an example of the first axis represents an index for identifying the order of each of the plurality of pieces of result data of interest and the vertical axis that is an example of the second axis represents the magnitude of the degree of contribution. Here, the graph corresponding to each of the at least one target variable of interest represents the degree of contribution that is given to the target variable of interest by the exogenous noise given to the source variable of interest corresponding to the index. For example, the display control unit 54 outputs a graph in which line types or plotted mark shapes are changed for each target variable of interest.

For example, the display control unit 54 can visually indicate to the user how the influence by the exogenous noise given to each of the at least one target variable of interest to the source variable of interest transitions according to the change in the index of the result data of interest.

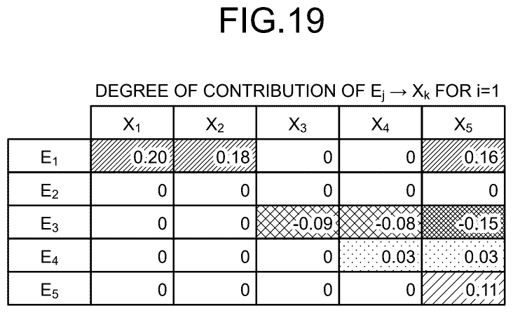

FIG. 19 is a diagram illustrating a ninth example of the cause information.

For example, the display control unit 54 may output the cause information of the ninth example as illustrated in FIG. 19 that includes a table in which one of the source variable of interest and the target variable of interest is a row and the other is a column. Here, the cell in the table includes a numerical value representing the degree of contribution by the exogenous noise given to the corresponding source variable of interest to the corresponding target variable of interest or a value obtained by converting the numerical value representing the degree of contribution by the exogenous noise given to the corresponding source variable of interest to the corresponding target variable of interest.

The cell in the table includes, in addition to or instead of the numerical value, a background image displayed in a highlighted manner according to the magnitude of the degree of contribution by the corresponding source variable of interest to the corresponding target variable of interest. That is, the display control unit 54 changes the degree of highlight of the cell according to the magnitude of the degree of contribution in the cell to display the table as a heat map. For example, the display control unit 54 changes a color or a density of the cell according to the magnitude of the degree of contribution.

As a result, the display control unit 54 can visually indicate to the user which combination of the source variable of interest and the target variable of interest is a combination having a large degree of contribution for the result data of interest.

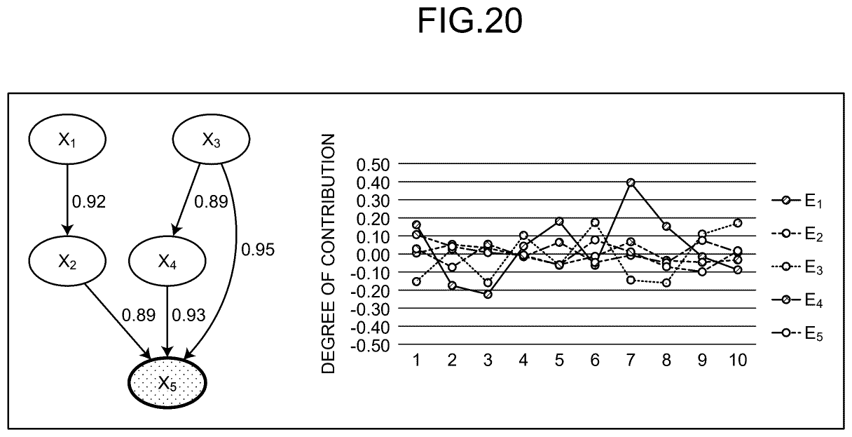

FIG. 20 is a diagram illustrating a first display example of the causal graph and the cause information.

The display control unit 54 may cause the display device to display image information representing the causal graph as illustrated in FIG. 20. Here, the selection receiving unit 52 selects a variable corresponding to an operated node among a plurality of nodes in the causal graph as the source variable of interest or the target variable of interest according to an operation such as click by the user. Then, the display control unit 54 causes the display device to display the cause information of the first to ninth examples based on the selected source variable of interest or the selected target variable of interest.

Note that the display control unit 54 may display a node selected by the user in the causal graph in a highlighted manner. For example, the display control unit 54 may display the node selected by the user with a thicker line than that of other nodes or may display the node in a color different from that of other nodes. The display control unit 54 may separately display the node selected as the source variable of interest and the node selected as the target variable of interest.

The display control unit 54 can visually indicate to the user the cause information together with the causal graph. As a result, the user can efficiently analyze the cause analysis result or the cause.

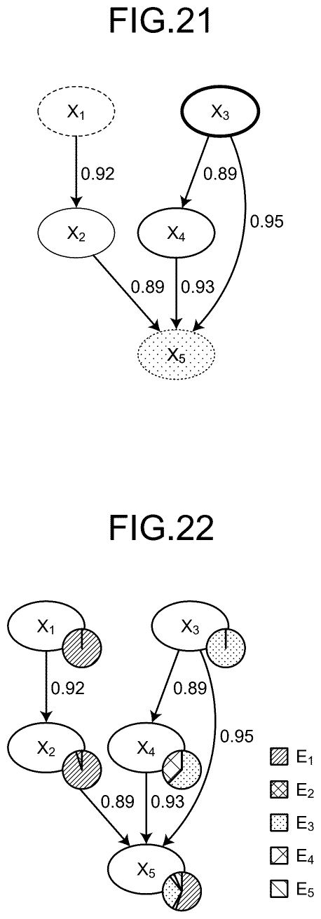

FIG. 21 is a diagram illustrating a second display example of the causal graph and the cause information.

When the image information representing the causal graph is displayed on the display device, the display control unit 54 selects a variable corresponding to the operated node among the plurality of nodes in the causal graph as the target variable of interest according to the operation such as click by the user. Here, the display control unit 54 selects each of the plurality of variables corresponding to the plurality of nodes in the causal graph as the source variable of interest.

Then, the display control unit 54 may display each of the plurality of nodes in a highlighted manner according to the degree of contribution when the corresponding variable is selected as the source variable of interest. For example, the display control unit 54 changes the size, color, thickness, or the like of the node according to the degree of contribution. The display control unit 54 may change the size, color, thickness, or the like of the node according to a ratio of the degree of contribution. For example, the display control unit 54 may change the size, color, thickness, or the like of the node according to a ratio of the magnitude of the degree of contribution, a ratio of the variance of the degree of contribution, a ratio of the standard deviation, a ratio of the sum of squares of the degree of contribution, or a ratio of the square root of the sum of squares. For example, the display control unit 54 may add, to each of the plurality of nodes, the degree of contribution when the corresponding variable is selected as the source variable of interest.

The display control unit 54 can visually indicate to the user the degree of contribution by the exogenous noise of each of the plurality of source variables of interest to the target variable of interest together with the causal graph. As a result, the user can efficiently analyze the cause analysis result or the cause.

FIG. 22 is a diagram illustrating a third display example of the causal graph and the cause information.

When the image information representing the causal graph is displayed on the display device, the display control unit 54 may display a circular graph corresponding to each of the plurality of nodes in the causal graph. The circular graph represents the ratio of the degree of contribution by the exogenous noise of the source variable of interest when the corresponding variable is the target variable of interest and the corresponding variable itself and the variable upstream of the corresponding variable are the source variables of interest. Here, for the most upstream node, that is, for a node having no parent node, the display control unit 54 displays a circular graph in which the degree of contribution by the exogenous noise of itself is 100%. Note that the ratio of the degree of contribution is similar to the cause information of the fifth example described with reference to FIG. 15.

As a result, the display control unit 54 can visually indicate to the user how the ratio of the degree of contribution when each of the plurality of variables is set as the target variable of interest changes according to the structure of the structural causal model.

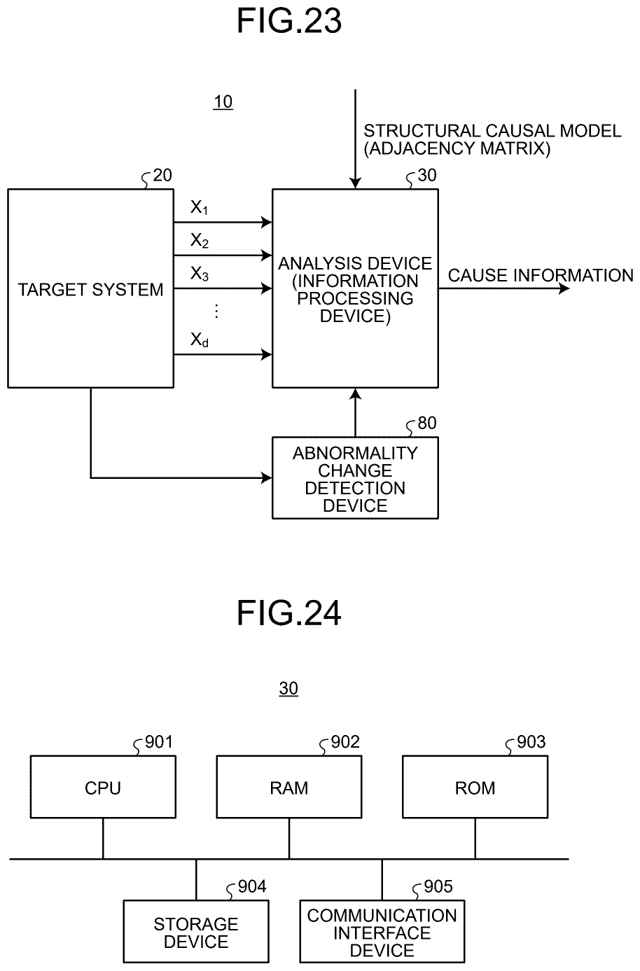

FIG. 23 is a diagram illustrating a modification of the information processing system 10 according to the embodiment. The information processing system 10 according to the modification further includes an abnormality change detection device 80.

For example, the analysis device 30 periodically acquires one or more pieces of result data including result values of a plurality of variables as a stationary task and outputs the cause information. Instead of or in addition to such processing, the analysis device 30 according to the modification acquires one or more pieces of result data including the result values of the plurality of variables as a nonstationary task in response to an instruction from the abnormality change detection device 80 and outputs the cause information.

The abnormality change detection device 80 acquires one or more pieces of result data and the like and detects occurrence of abnormality or possibility of abnormality in the target system 20 or a change in the state of the target system 20. The abnormality change detection device 80 gives an operation instruction to the analysis device 30 when a change in the state of the target system 20 is detected. For example, the abnormality change detection device 80 may determine the state of the target system 20 by comparing a quantile, a standard deviation, and the like in the result value of any variable to be monitored among the plurality of variables with a preset threshold. For example, the abnormality change detection device 80 may determine the state of the target system 20 by testing an average value, a standard deviation, and the like in the result value of the variable to be monitored. For example, the abnormality change detection device 80 may individually determine each of two or more variables to be monitored among the plurality of variables, and may determine that there is an abnormality, a change, or an abnormality and a change in the state of the target system 20 when any of the two or more variables to be monitored or a predetermined number thereof is detected.

The abnormality change detection device 80 may collectively perform multivariate analysis on any two or more variables to be monitored among the plurality of variables to determine the state of the target system 20. For example, the abnormality change detection device 80 may determine the state of the target system 20 using a method based on Hotelling's Statistic, k-NN, SVM, CAE, a graphical model, a density ratio, and the like for two or more variables to be monitored.

By including the abnormality change detection device 80, the information processing system 10 can support a work of identifying a factor of generation of the abnormality, the change, or the abnormality and the change detected by the abnormality change detection device 80.

When the target system 20 is a system that manufactures a product, the target system 20 monitors and manages quality characteristics of the product by using a control chart. The control chart includes information defining control limits or specification limits of values representing quality characteristics of a product.

Here, the plurality of variables include quality characteristics of the product defined in the control chart as variables. The structural causal model set for the analysis device 30 includes the quality characteristics of the product defined in the control chart as variables.

The abnormality change detection device 80 causes the analysis device 30 to execute processing when the result value of the variable representing the quality characteristic of the product deviates from the control limits or the specification limits. The analysis device 30 performs root cause analysis by using variables corresponding to the quality characteristics deviating from the control limits and the specification limits as target variables when the quality characteristics of the product deviate from the control limits and the specification limits illustrated in the control chart. As a result, the analysis device 30 can clarify, for example, raw materials, processes, and quality characteristics that are fundamental causes of the quality characteristics deviating from the control limits or the specification limits. As a result, the user can perform cause investigation and countermeasure by combining the cause information output from the analysis device 30 and the control chart.

### Hardware Configuration of Analysis Device 30 and the Like

FIG. 24 is a diagram illustrating an example of a hardware configuration of the analysis device 30. The analysis device 30 is realized by, for example, an information processing device having a hardware configuration as illustrated in FIG. 24. The analysis device 30 includes a central processing unit (CPU) 901, a random access memory (RAM) 902, a read only memory (ROM) 903, a storage device 904, and a communication interface device 905. The units are connected to each other via a bus.

The CPU 901 is one or more processors that execute arithmetic processing, control processing, and the like according to programs. The CPU 901 uses a predetermined area of the RAM 902 as a work area and executes various kinds of processing in cooperation with programs stored in the ROM 903, the storage device 904, and the like.

The RAM 902 is a memory such as a synchronous dynamic random access memory (SDRAM). The RAM 902 functions as a work area of the CPU 901. The ROM 903 is a memory that stores programs and various kinds of information in a non-rewritable manner.

The storage device 904 is a device that writes and reads data to and from a semiconductor storage medium such as a flash memory, a magnetically or optically recordable storage medium, or the like. The storage device 904 writes and reads data to and from the storage medium under control of the CPU 901. The communication interface device 905 communicates with an external device via a network under control of the CPU 901.

The programs executed by the information processing device cause the information processing device to function as the analysis device 30. The programs are loaded and executed on the RAM 902 by the CPU 901 (processor).

The programs executed by the information processing device are provided as files in a format installable or executable in the information processing device by being recorded in a recording medium readable by the information processing device such as a CD-ROM, a flexible disk, a CD-R, and a digital versatile disk (DVD).

The programs may be configured to be stored on a computer connected to a network such as the Internet and be provided by being downloaded via the network. The programs may be configured to be provided or distributed via a network such as the Internet. The programs executed by the analysis device 30 may be provided by being incorporated in the ROM 903 or the like in advance.

The programs for causing the information processing device to function as the analysis device 30 include, for example, a result data acquisition module, a model acquisition module, an exogenous noise estimation module, a contribution decomposition module, and an output module. The programs are executed by the CPU 901 to load each module into the RAM 902 and cause the CPU 901 to function as the result data acquisition unit 32, the model acquisition unit 36, the exogenous noise estimation unit 40, the contribution decomposition unit 42, and the output unit 46. When the CPU 901 is configured of a plurality of processors, the units may be divided by the plurality of processors. Note that a part or all of the configurations may be configured as hardware. The programs cause the RAM 902 and the storage device 904 to function as the result data storage unit 34, the model storage unit 38, and the decomposition result storage unit 44.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An information processing device comprising
a processing unit comprising at least one hardware processor configured to:
calculate a plurality of exogenous noise estimation values corresponding to a plurality of variables for each of one or more pieces of result data including a plurality of result values respectively corresponding to the plurality of variables based on the one or more pieces of result data and a structural causal model representing a causal relationship of the plurality of variables, each the plurality of exogenous noise estimation values representing an estimation value of influence by an exogenous noise that is different from influences from the plurality of variables with respect to corresponding variables among the plurality of variables; and
generate a degree of contribution representing a magnitude of influence by the exogenous noise given to a source variable that is one variable of two variables to a target variable that is another variable of the two variables for each combination of the two variables in the plurality of variables for the one or more pieces of result data based on the structural causal model and the plurality of exogenous noise estimation values for each of the one or more pieces of result data.

2. The information processing device according to claim 1, wherein
the structural causal model is represented using an adjacency matrix representing a magnitude of influence of one variable on another variable for each combination of two variables in the plurality of variables.

3. The information processing device according to claim 2, wherein
the at least one hardware processor calculates an exogenous noise matrix by multiplying a result data matrix including the one or more pieces of result data with a matrix obtained by subtracting the adjacency matrix from an identity matrix; and
the exogenous noise matrix includes the plurality of exogenous noise estimation values for each of the one or more pieces of result data.

4. The information processing device according to claim 3, wherein
when a first variable among the plurality of variables is set as the target variable and a second variable among the plurality of variables is set as the source variable in first result data among the one or more pieces of result data, the degree of contribution for the combination of the two variables is
a value of a term including an exogenous noise estimation value representing the exogenous noise given to the second variable among a plurality of terms in a linear sum formula,
the linear sum formula is a formula for performing a product-sum operation of a row or a column corresponding to the first result data in the exogenous noise matrix and a row or a column corresponding to the first variable in a coefficient matrix, and
the coefficient matrix is an inverse matrix or a generalized inverse matrix of the matrix obtained by subtracting the adjacency matrix from the identity matrix.

5. The information processing device according to claim 1, wherein
the at least one hardware processor generates a third-order tensor including an i component, a j component, and a k component,
the i component corresponds to each of the one or more pieces of result data,
the j component corresponds to each of the plurality of variables,
the k component corresponds to each of the plurality of variables, and
an element in the third-order tensor represents the degree of contribution for result data identified by the i component among the one or more pieces of result data, in which a variable identified by the j component among the plurality of variables is set as the source variable and a variable identified by the k component among the plurality of variables is set as the target variable.

6. The information processing device according to claim 2, wherein
the adjacency matrix is estimated by using a causal discovery algorithm based on the one or more pieces of result data.

7. The information processing device according to claim 2, wherein
the adjacency matrix is estimated by using a known causal structure and covariance structure analysis based on the one or more pieces of result data.

8. The information processing device according to claim 2, wherein
the adjacency matrix is estimated by using information concerning presence or absence of a cause and effect between variables and a causal discovery algorithm based on the one or more pieces of result data.

9. The information processing device according to claim 1, wherein
the at least one hardware processor
receives selection of result data of interest among the one or more pieces of result data, a source variable of interest among the plurality of variables, and a target variable of interest among the plurality of variables.

10. The information processing device according to claim 1, wherein
the at least one hardware processor
outputs cause information indicative of the degree of contribution for result data of interest among the one or more pieces of result data, in which a source variable of interest among the plurality of variables is set as the source variable and a target variable of interest among the plurality of variables is set as the target variable.

11. The information processing device according to claim 10, wherein
the cause information includes a table or a graph representing degrees of contribution corresponding to combinations between all of source variables of interest and target variables of interest in at least one of the source variables of interest and at least one of the target variables of interest for at least one piece of the result data of interest.

12. The information processing device according to claim 10, wherein
the cause information includes a graph corresponding to each of at least one of the source variables of interest in a planar area of which a position is identified by a first axis representing an index identifying each of the one or more pieces of result data and a second axis representing the degree of contribution, and
the graph corresponding to each of the at least one of the source variables of interest represents the degree of contribution that is given to the target variable of interest by the exogenous noise given to the source variable of interest corresponding to the index.

13. The information processing device according to claim 12, wherein
the second axis further represents a result value of the target variable of interest, and
the cause information further includes a graph that represents the result value of the target variable of interest corresponding to the index and that is depicted in the planar area.

14. The information processing device according to claim 10, wherein
the cause information includes a circular graph or a bar graph representing a ratio of the degree of contribution by each of the plurality of source variables of interest for the result data of interest, and
the ratio of the degree of contribution represents a ratio of a magnitude of a degree of contribution by the exogenous noise of the corresponding source variable of interest to the target variable of interest with respect to a total value of the magnitude of the degree of contribution by the exogenous noise of each of the plurality of source variables of interest to the target variable of interest or represents a ratio of a statistical value of the degree of contribution by the exogenous noise of the corresponding source variable of interest to the target variable of interest with respect to a total value of the statistical value of the degree of contribution by the exogenous noise of each of the plurality of source variables of interest to the target variable of interest.

15. The information processing device according to claim 10, wherein
the cause information includes a bar graph or a waterfall graph indicating the degree of contribution by each of the plurality of source variables of interest for the result data of interest.

16. The information processing device according to claim 10, wherein
the cause information includes a graph corresponding to each of at least one of the target variables of interest in a planar area of which a position is identified by a first axis representing an index identifying each of the one or more pieces of result data and a second axis representing the degree of contribution, and
the graph corresponding to each of the at least one of the target variables of interest represents the degree of contribution that is given to the corresponding target variable of interest by the exogenous noise given to the source variable of interest corresponding to the index.

17. The information processing device according to claim 10, wherein
the cause information includes a table in which one of a column and a row indicates the source variable of interest and the other indicates the target variable of interest for the result data of interest, and
a cell in the table includes a background image displayed in a highlighted manner according to a numerical value representing the degree of contribution that is given to the corresponding target variable of interest by the exogenous noise given to the corresponding source variable of interest and/or the degree of contribution that is given to the corresponding target variable of interest by the corresponding source variable of interest.

18. The information processing device according to claim 10, wherein
the at least one hardware processor
displays a causal graph representing the structural causal model,
each of a plurality of nodes in the causal graph represents any one of the plurality of variables, and
a variable corresponding to a node operated by a user among the plurality of nodes in the causal graph is selected as the source variable of interest or the target variable of interest.

19. The information processing device according to claim 10, wherein
the at least one hardware processor
displays a causal graph representing the structural causal model,
each of a plurality of nodes in the causal graph represents any one of the plurality of variables, and
each of a plurality of nodes is displayed in a highlighted manner according to the degree of contribution when a corresponding variable is selected as the source variable of interest in response to selection of any one of the plurality of nodes in the causal graph as the target variable of interest by a user.

20. The information processing device according to claim 10, wherein
the at least one hardware processor
displays a causal graph representing the structural causal model,
each of a plurality of nodes in the causal graph represents any one of the plurality of variables,
an image including a circular graph or a bar graph is displayed correspondingly to each of the plurality of nodes,
the circular graph or the bar graph represents a ratio of the degree of contribution for each of the plurality of the source variables of interest when the corresponding variable or a variable upstream of the corresponding variable in the causal graph is set as the source variable of interest, and
the ratio of the degree of contribution represents a ratio of a magnitude of a degree of contribution by the exogenous noise of the corresponding source variable of interest to the target variable of interest with respect to a total value of the magnitude of the degree of contribution by the exogenous noise of each of the plurality of source variables of interest to the target variable of interest or represents a ratio of a statistical value of the degree of contribution by the exogenous noise of the corresponding source variable of interest to the target variable of interest with respect to a total value of the statistical value of the degree of contribution by the exogenous noise of each of the plurality of source variables of interest to the target variable of interest.

21. An information processing system comprising:
the information processing device according to claim 20; and
an abnormality change detection device comprising at least one hardware processor configured to:
detect an abnormality or a change in a state of a target system that outputs the one or more pieces of result data; and
cause the information processing device to generate the degree of contribution when the abnormality or the change in the state of the target system is detected.

22. The information processing system according to claim 21, wherein
the target system is a system that manufactures a product,
the plurality of variables includes a quality characteristic of the product as a variable, and
the at least one hardware processor of the abnormality change detection device causes the information processing device to generate the degree of contribution when a result value of the variable representing the quality characteristic of the product deviates from control limits or specification limits defined by a control chart generated in advance.

23. An information processing method executed by a computer of an information processing device, the method comprising:
calculating a plurality of exogenous noise estimation values corresponding to a plurality of variables for each of one or more pieces of result data including a plurality of result values respectively corresponding to the plurality of variables based on the one or more pieces of result data and a structural causal model representing a causal relationship of the plurality of variables, each the plurality of exogenous noise estimation values representing an estimation value of influence by an exogenous noise that is different from influences from the plurality of variables with respect to corresponding variables among the plurality of variables; and
generating a degree of contribution representing a magnitude of influence by the exogenous noise given to a source variable that is one variable of two variables to a target variable that is another variable of the two variables for each combination of the two variables in the plurality of variables for the one or more pieces of result data based on the structural causal model and the plurality of exogenous noise estimation values for each of the one or more pieces of result data.

24. A computer program product having a non-transitory computer readable medium including programmed instructions, wherein the instructions, when executed by a computer of an information processing device, cause the computer to execute:
calculating a plurality of exogenous noise estimation values corresponding to a plurality of variables for each of one or more pieces of result data including a plurality of result values respectively corresponding to the plurality of variables based on the one or more pieces of result data and a structural causal model representing a causal relationship of the plurality of variables, each the plurality of exogenous noise estimation values representing an estimation value of influence by an exogenous noise that is different from influences from the plurality of variables with respect to corresponding variables among the plurality of variables; and
generating a degree of contribution representing a magnitude of influence by the exogenous noise given to a source variable that is one variable of two variables to a target variable that is another variable of the two variables for each combination of the two variables in the plurality of variables for the one or more pieces of result data based on the structural causal model and the plurality of exogenous noise estimation values for each of the one or more pieces of result data.
